(19) United States
(12) Patent Application Publication
(10) Pub. No.: US 2018/0254583 A1
(43) Pub. Date: Sep. 6, 2018

(54) AN ELECTRICAL CONNECTION SYSTEM FOR USE IN HIGH POWER APPLICATIONS

(71) Applicant: CONNEC LIMITED, Rushcutters Bay, New South Wales (AU)

(72) Inventor: Stephen Williams, Rushcutters Bay, New South Wales (AU)

(21) Appl. No.: 15/759,268

(22) PCT Filed: Sep. 10, 2015
(86) PCT No.: PCT/AU2015/000562

§ 371 Date: Mar. 12, 2018

(51) Int. Cl. H01R 13/629; H01R 13/53; H01R 13/621

(52) U.S. Cl. CPC H01R 13/62977; H01R 24/20; H01R 13/6215; H01R 13/53

(57) ABSTRACT

The present disclosure provides an electrical connection system that comprises a first electrical connection component that is suitable for transmission of power with a voltage level greater than 0.5 k V and is arranged for coupling to a second electrical connection component suitable for transmission of power with a voltage level greater than 0.5 k V. Further, the electrical connection system comprises a mechanical coupling assembly that has first and second portions. The first portion is removeably engageable with the first electrical connection component and the second portion is removeably engageable with the second electrical connection component. The mechanical coupling assembly is structured to drive the first electrical connection component and the second electrical connection component relative to each other along a central axis of the electrical connection system and between disengaged and engaged conditions.

### FIELD OF THE INVENTION

The present invention relates to an electrical connection system for use in high power applications. In particular, though not exclusively, the present invention relates to an electrical connection system suitable for use in high power applications in demanding environments such as the petroleum or mining industry.

### BACKGROUND OF THE INVENTION

Reliable electrical connections are crucial in high power applications, such as powering of heavy electrical machinery often used in the mining or petroleum industry. In these applications the electrical cables transmit high currents at high voltages.

Typical electrical connectors used in the art have a plurality of pins or sockets, each being connected to a respective core of an electrical cable. Depending on the specific application, the connectors must comply with specific requirements or standards. The compliance of the connectors with the relevant standards is examined by a certifying body.

In an explosive environment, for example, particular precaution must be taken and a flame path may be required between connectors to reduce likelihood of explosions. The flame path typically is formed between a plug and a receptacle by positioning a cylindrical surface that surrounds contacts and/or electrical leads of the plug inside a respective surface of a receptacle. The mechanical tolerance between the cylindrical surfaces is fine (typically 0.2 to 0.4 mm). As a consequence of the fine mechanical tolerance, canting or seizing may occur which makes it difficult to engage or disengage the plug and the receptacle form each other.

U.S. Pat. No. 7,318,738 (owned by the present applicant) discloses a drive for driving electrical connection devices between engaged and disengaged conditions along a central axis.

The present invention provides further improvement.

### SUMMARY OF THE INVENTION

The present invention provides an electrical connection system that comprises:
a first electrical connection component that is suitable for transmission of power with a voltage level greater than 0.5 kV and is arranged for coupling to a second electrical connection component suitable for transmission of power with a voltage level greater than 0.5 kV; and
a mechanical coupling assembly having first and second portions, the first portion being removeably engageable with the first electrical connection component and the second portion being removeably engageable with the second electrical connection component, the mechanical coupling assembly being structured to drive the first electrical connection component and the second electrical connection component relative to each other along a central axis of the electrical connection system and between disengaged and engaged conditions.

The first electrical connection component and the mechanical coupling assembly may be structured such that the first portion of the mechanical coupling assembly is lockable in position on the first electrical connection component by a movement of the mechanical coupling assembly relative to the first electrical connection component. Further, the first electrical connection component and the mechanical coupling assembly may be structured such that the first portion of the mechanical coupling assembly is removable from the first electrical connection component by a movement of the mechanical coupling assembly relative to the first electrical connection component.

Embodiments of the present invention have practical advantages. Electrical connection components, such as plugs and receptacles for mobile machinery that require high currents at high voltage (such as 0.6, 3.3, 11 kV or higher) are usually relatively heavy components and consequently using these components is cumbersome. The mechanical coupling assembly facilities connecting these components together, but can be removed. Consequently it can be avoided that the mechanical coupling assembly adds weight to the electrical connection components when the connection components need to be moved.

The mechanical coupling assembly and the first electrical connection component may be structured such that the first portion of the mechanical coupling assembly can be keyed in position on the first electrical connection component.

In one specific embodiment the first electrical connection component has at least one projection that is transversal relative to the central axis of the electrical connection system and the mechanical coupling assembly has at least one recess for receiving the at least one projection such that the first electrical connection component and the mechanical coupling assembly are keyed together.

Additionally or alternatively, the mechanical coupling assembly has at least one projection that is transversal relative to the central axis of the electrical connection system and the first electrical connection component has at least one recess for receiving the at least one projection such that the first electrical connection component and the mechanical coupling assembly are keyed together.

Further, the first portion of the mechanical coupling assembly may be engageable with the first electrical connection component by clamping such that the first portion of the mechanical coupling assembly surrounds at least a portion of the circumference of the first electrical connection component.

The first portion of the mechanical coupling assembly and the first electrical connection component may also be arranged for frictionally engaging with each other.

The mechanical coupling assembly may be arranged to distribute the driving force in substantially equal portions exclusively to spaced apart eccentric positions having respective angular orientations around the central axis. In one embodiment the mechanical coupling assembly is arranged to distribute the driving force to two spaced apart positions, such as two eccentric positions that are opposite each other.

The mechanical coupling assembly may have portions that comprise, or are composed of, a high density polymeric material.

The mechanical coupling assembly may comprise a geared arrangement and rods that in use are driven by the geared arrangement and are arranged to drive the first and second portions of the mechanical coupling assembly relative to each other. The geared arrangement may be positioned in the first portion of the mechanical coupling assembly and may comprise a ratcheting mechanism for imparting drive.

In one specific embodiment the mechanical coupling assembly comprises two rods that may be threaded and that are oriented along the central axis of the electrical connection system and are positioned at respective eccentric positions and respective angular orientations around the central axis.

The first electrical connection component may have a connection end at which it is arranged for connection to the second electrical connection component and may have a machine cable end at which it is arranged for connection to a machine cable.

The system may comprise the second electrical connection component.

In one embodiment, the second electrical connection component has a connection end at which it is arranged for connection to the first electrical connection component and a machine cable end at which it is arranged for connection to a machine cable. The first electrical connection component may be a plug and the second electrical connection component may be a receptacle. Alternatively, the first electrical connection component may be a receptacle and the second electrical connection component may be a plug.

In an alternative embodiment the first electrical connection component comprises a connection part and a transfer part. The connection part may have a connection end at which it is arranged for connection to the transfer part and a machine cable end at which it is arranged for connection to a machine cable. The transfer part may have first and second coupling faces. The first coupling face of the transfer part may be arranged for coupling to the connection part and the second coupling face may be arranged for coupling to the second electrical connection component such that the transfer part is sandwiched between the connection part and the second electrical connection component. For example, the connection part and the second electrical connection component may both be plugs and the transfer part may have female connections at each coupling face for coupling to the two plugs. Alternatively, the connection part of the first electrical connection component and the second electrical connection component may both be receptacles and the transfer part may have male connection elements at each coupling face for coupling to the two receptacles.

In this embodiment the first portion of the mechanical coupling assembly may be removeably engageable with the connection part of the first electrical connection component and the second portion of the mechanical coupling assembly may be removeably engageable with the transfer part of the first electrical connection component. The mechanical coupling assembly may be structured to drive the connection part and the transfer part relative to each other and between disengaged and engaged conditions. Further, when the connection part and the transfer part are in the engaged condition, the second portion of the mechanical coupling assembly may be removeably engageable with the second electrical connection component and the mechanical coupling assembly may be arranged to drive the first electrical connection component (including the transfer part and the connection part) and the second electrical connection component relative to each other and between disengaged and engaged conditions.

The invention will be more fully understood from the following description of specific embodiments of the invention. The description is provided with reference to the accompanying drawings.

### BRIEF DESCRIPTION OF THE DRAWINGS

FIGS. 1 and 2 are views of an electrical connection system in accordance with an embodiment of the present invention;

FIG. 3 is a views of an electrical connection component in accordance with an embodiment of the present invention; and

FIGS. 4 and 5 are views of an electrical connection system in accordance with another embodiment of the present invention.

### DETAILED DESCRIPTION OF SPECIFIC EMBODIMENTS

Embodiments described herein provide an electrical connection system for connecting to machine cables suitable for high power applications. The electrical connection system comprises first and second electrical connection components that are arranged for coupling to each other. For example, the first electrical connection component may be a plug comprising pins and the second electrical connection component may be a receptacle comprising sockets. The electrical connection components are suitable for transmission of power with voltage levels greater than 0.5 kV (such as 0.5 kV, 3.3 kV or 11 kV).

The electrical connection system comprises a mechanical coupling assembly for imparting a driving force to drive the first and second electrical connection components relative to each other along a central axis between disengaged and engaged conditions. The mechanical coupling assembly has first and second portions. In one example the first portion of the mechanical coupling assembly and the first electrical connection component are structured such that the first portion of the mechanical coupling assembly can be keyed in position on the first electrical connection component. Alternatively, the first portion may be engageable with the first electrical connection component by clamping the first portion partially around the first electrical connection component. The first portion of the mechanical coupling assembly and the first electrical connection component may also be arranged for frictionally engaging with each other.

The mechanical connection assembly further comprises in this embodiment a ratcheting system for applying a force manually to the mechanical connection assembly which has a transmission that distributes portions of the driving force substantially equally between first and second eccentric positions around the central axis. The first and second positions are in this embodiment opposite to each other.

In one embodiment one of the first and second electrical connection components is a plug and the other one of the first and second electrical connection components is a receptacle. The first and second electrical connection components have in this embodiment cylindrical flame path surfaces between which a flame path is defined when the first and second electrical connection components are engaged.

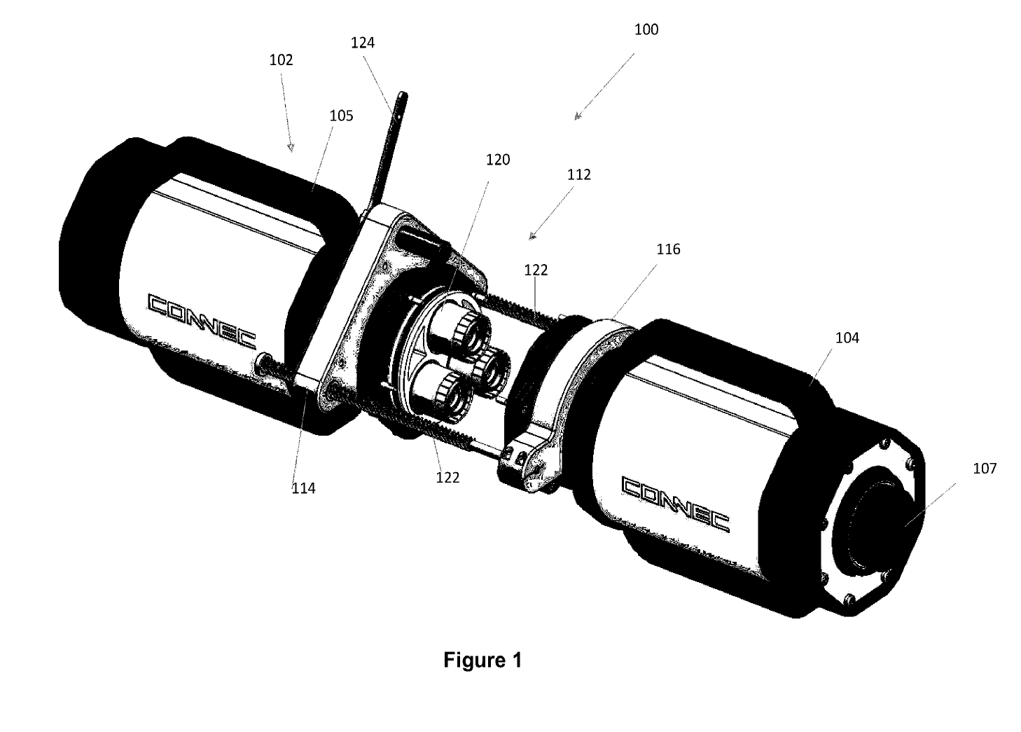

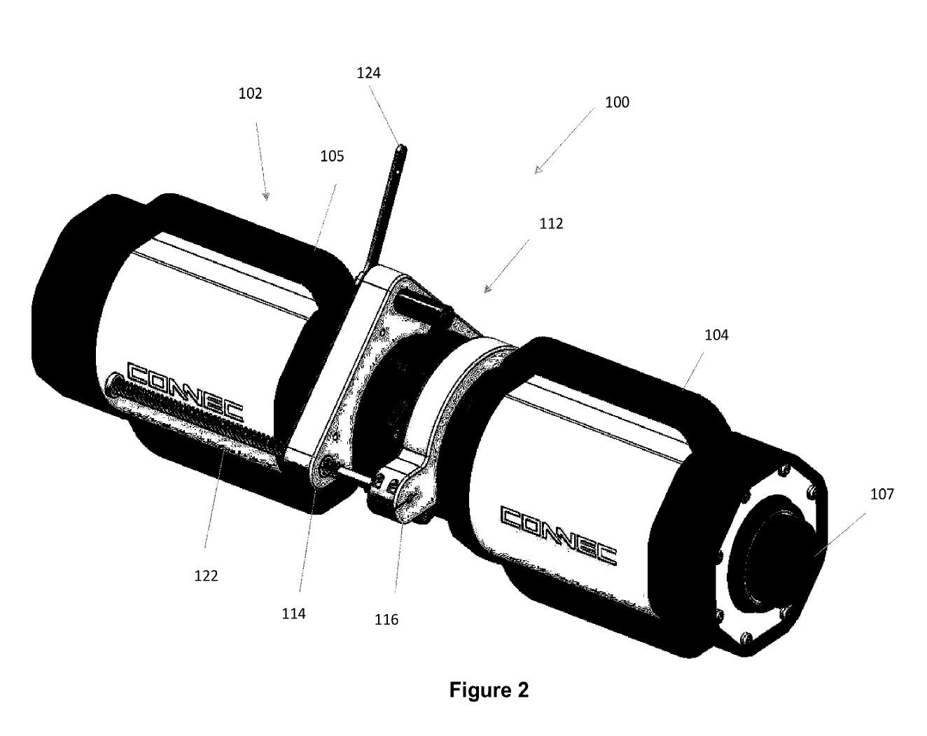

Referring initially to FIGS. 1 and 2, there is shown an electrical connection system 100 in accordance with an embodiment of the present invention. The electrical connection system 100 comprises a first electrical connection component 102 and a second electrical connection component 104. The electrical connection components 102 and 104 are of the above described type and are arranged for the delivery of high power at high voltages and are suitable for transmission of power to mobile machinery in mining environments. The electrical connection components 102 and 104 each have a connection side at which electrical contacts are positioned and a machine cable side at which the electrical connection components 102 and 104 are arranged for coupling to a machine cable 107.

In this embodiment the electrical connection component 102 comprises a transfer part 120 and a connection part 105. The connection part 105 and the second electrical connection component 104 are identical components.

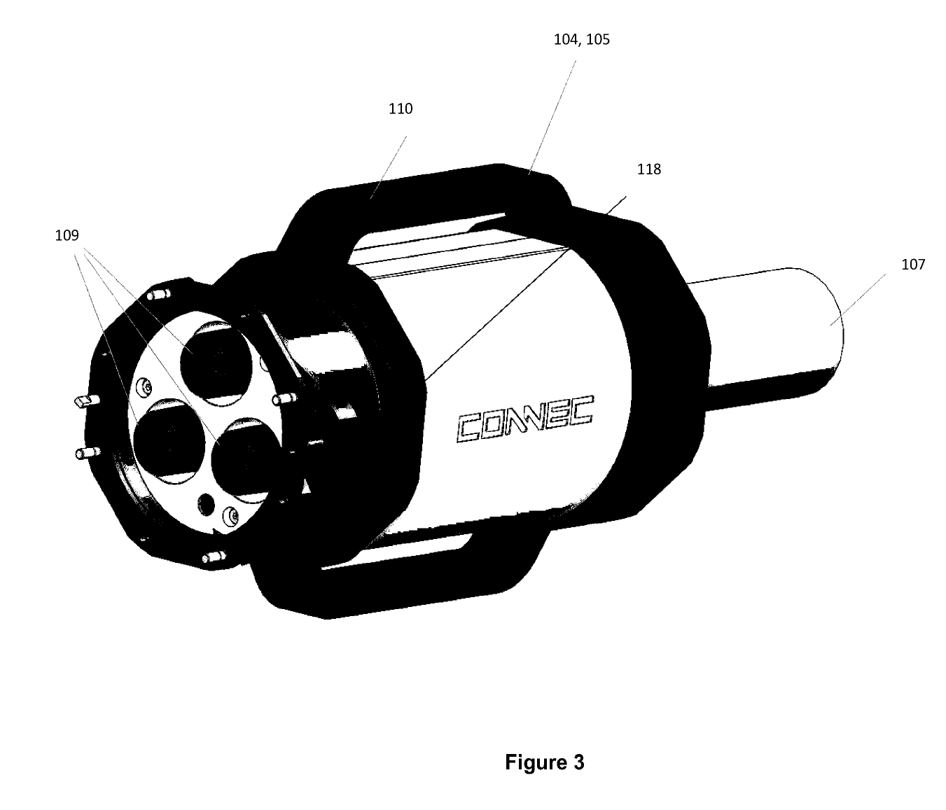

FIG. 3 shows the second electrical connection component 104 in more detail. The electrical connection component 104 has an electrical connection assembly 109 in a housing 110. In this embodiment the housing 110 and further components of the electrical connection components are formed from a high density polymeric material.

Referring now back to FIGS. 1 and 2, the electrical connection system 100 comprises a mechanical coupling assembly 112. The mechanical coupling assembly 112 comprises a first component 114 and a second component 116. The first component 114 is engaged with the first electrical connection component 102. The electrical connection components 102 and 104 have projections and the first and second portions 114, 116 of the mechanical coupling assembly 112 have corresponding recesses. FIG. 3 shows one of the projections 118 (the electrical connection components 102, 104 have in this embodiment each two such projections at opposite positions). The first portion 114 of the mechanical coupling assembly 112 and the electrical connection component 102 are keyed together and the projections 118 are received by the corresponding recesses of the first component 114 of the mechanical coupling assembly 112.

In this embodiment the first portion 114 of the mechanical coupling assembly 112 is positioned on the first electrical connection component 102 in a manner such that it is secured in position along a central axis of the electrical connection system 100, but can be removed by applying a force to the first component 114 in a direction away from the central axis.

The second component 116 of the mechanical coupling assembly 112 is keyed in position onto the second electrical connection component 104 in the same manner as the first component 114 is keyed onto the first electrical connection component 102.

In this embodiment, the transfer part 120 is a receptacle and comprises female electrical contacts. As mentioned above, the coupling part 105 and the second electrical connection component 104 are identical components and in this embodiment are plugs. Further, the transfer part 120 has female contacts that are engaged with male contacts of the coupling part 105. The transfer part 120 is removeably attachable from a coupling part 105 of the first electrical connection component 102.

The mechanical coupling assembly 112 has in this embodiment rods 122 having helical threads. The first component 114 of the mechanical coupling assembly 112 has a ratcheting mechanism (not shown) that is operable by moving lever arm 124. The ratcheting mechanism drives gears (not shown) that move the threaded rods 112. An end of each threaded rod 112 is engaged with the second portion 116 of the mechanical coupling assembly 112. Movement of the lever arm 124 causes movement of the gears within the first component 114 of the mechanical coupling assembly 112 to such that the rods 122 move along a central axis of the electrical connection system 100. As a consequence, the first portion 114 and the second portion 116 of the mechanical coupling assembly 112 move relative to each other and the first electrical connection component 102 and the second electrical connection component 104 move between engaged and disengaged conditions.

FIG. 1 shows the first and second electrical connection components 102, 104 in a disengaged condition and FIG. 2 the first and second connection components 102, 104 in an engaged condition. Once the first electrical connection component 102 and the second electrical connection component 104 are engaged to each other, they are secured together using suitable bolts and the mechanical coupling assembly is removed by applying a force in a transversal direction away from the central axis to disengage the projections 118 from corresponding recesses.

In this embodiment the first portion 114 comprises a housing that is formed from a high density polymeric material. Further, the gears of the first portion 114 together with the ratcheting mechanism are in this embodiment formed from a high density polymeric material. The second portion 116 of the mechanical coupling assembly 112 is also formed from a high density polymeric material. It will be appreciated, however, that the high density polymeric material may be replaced by another material, such as a suitable metallic material.

Further, it will be appreciated that the mechanical coupling assembly 112 may take different forms. For example, the mechanical coupling assembly 112 may comprise any number of threaded rods and the threaded rods may not necessary be positioned opposite each other with respect to the central axis.

For further details of electrical components of the electrical connection components 102 and 104 reference is being made to the applicant's co-pending PCT international application numbers PCT/AU2014/001077, PCT/AU2014/001076, PCT/AU2014/001082 and PCT/AU2014/001083.

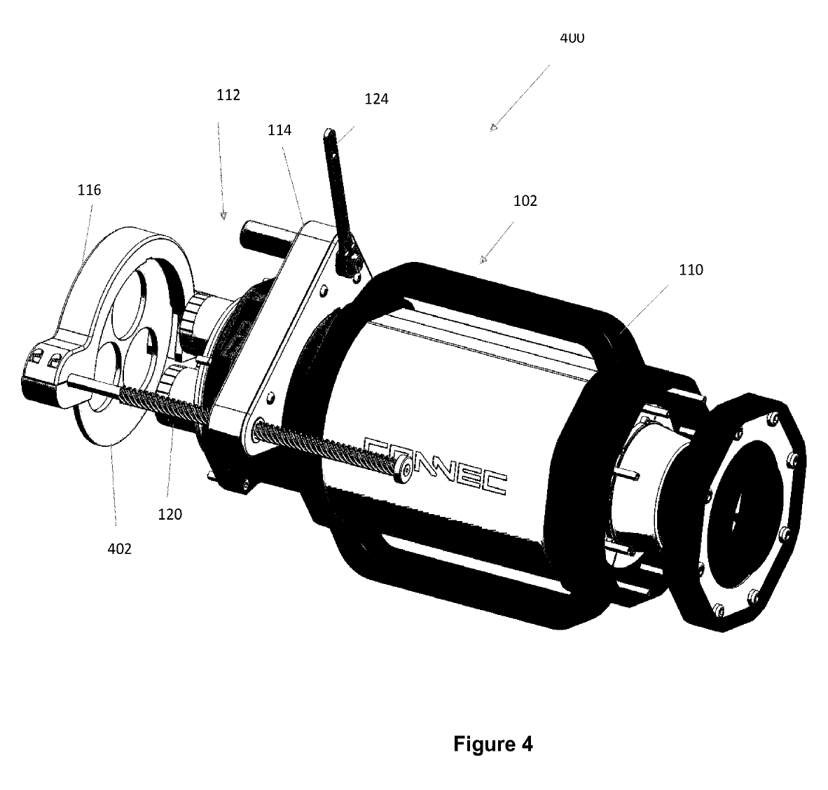

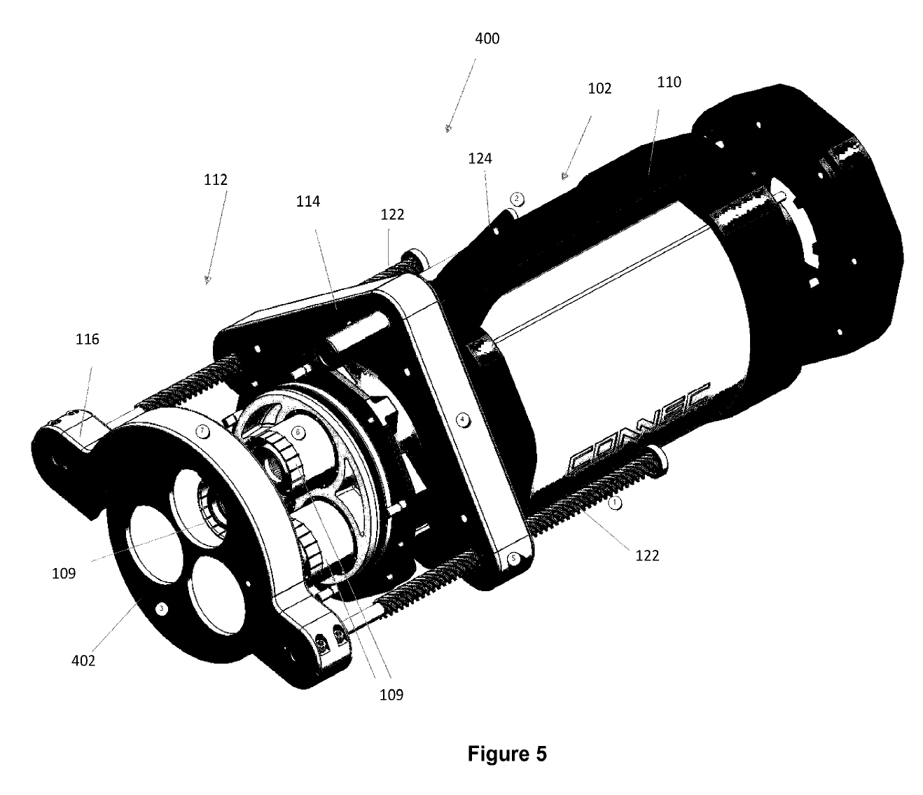

Referring now to FIGS. 4 and 5, an electrical connection system 400 in accordance with another specific embodiment of the present invention is described. The electrical connection system 400 comprises the above described first electrical connection component 102 and the above described mechanical coupling assembly 112. In this embodiment, the first portion 114 of the mechanical coupling assembly 112 is engaged with the first electrical connection component 102 in the above described manner. The second component 116 of the mechanical coupling assembly 112 is in this embodiment engaged with a disc-like member 402. The disc-like member 402 is arranged for coupling to the transfer part 120.

In this embodiment the above described mechanical coupling assembly 112 is used to drive the transfer part 120 and the connection part 105 between engaged and disengaged conditions. Once the transfer part 120 is engaged with the connection part 105 of the first electrical connection component 102, the mechanical coupling assembly 112 can be used to drive the disc-like member 402 away from the transfer part 120 and the mechanical coupling assembly 112 can then simply removed from the electrical connection component 102. Alternatively, the mechanical coupling assembly 112 can be engaged with the second electrical connection component 102 and can be used to couple the first and second electrical connection components 102, 104 to each other as described above with respect to FIGS. 1 and 2.

The reference that is being made to the applicant's co-pending PCT international applications and U.S. Pat. No. 7,318,738 does not constitute an admission that the disclosure of the applicant's co-pending PCT international applications U.S. Pat. No. 7,318,738 are part of the common general knowledge in Australia or any other country.

1. An electrical connection system that comprises:
first and second electrical connection components that are suitable for transmission of power with a voltage level greater than 0.5 kV and are arranged for coupling to each other; and
a mechanical coupling assembly having first and second portions, the first portion being removeably engageable with the first electrical connection component, and the second portion being removeably engageable with the second electrical connection component, the mechanical coupling assembly being structured to drive the first electrical connection component and the second electrical connection component relative to each other along a central axis of the electrical connection system and between disengaged and engaged conditions when engaged with the first and second electrical connection components;
wherein the mechanical coupling assembly is removeable from the first and second electrical connection components whereby it can be avoided that the mechanical coupling assembly adds weight to the electrical connection components when the connection components need to be moved.

2. The electrical connection system of claim 1 wherein the first electrical connection component and the mechanical coupling assembly are structured such that the first portion of the mechanical coupling assembly is lockable in position on the first electrical connection component by a movement of the mechanical coupling assembly relative to the first electrical connection component.

3. The electrical connection system of claim 1 wherein the first electrical connection component and the mechanical coupling assembly are structured such that the first portion of the mechanical coupling assembly is removable from the first electrical connection component by a movement of the mechanical coupling assembly relative to the first electrical connection component.

4. The electrical connection system of claim 1 wherein the mechanical coupling assembly and the first electrical connection component are structured such that the first portion of the mechanical coupling assembly can be keyed in position on the first electrical connection component.

5. The electrical connection system of claim 1 wherein the first electrical connection component has at least one projection that is transversal relative to the central axis of the electrical connection system and the mechanical coupling assembly has at least one recess for receiving the at least one projection such that the first electrical connection component and the mechanical coupling assembly are keyed together.

6. The electrical connection system of claim 1 wherein the mechanical coupling assembly has at least one projection that is transversal relative to the central axis of the electrical connection system and the first electrical connection component has at least one recess for receiving the at least one projection such that the first electrical connection component and the mechanical coupling assembly are keyed together.

7. The electrical connection system of claim 1 wherein the mechanical coupling assembly is arranged to distribute the driving force in substantially equal portions exclusively to spaced apart eccentric positions having respective angular orientations around the central axis.

8. The electrical connection system of claim 1 wherein the mechanical coupling assembly has portions that comprise a high density polymeric material.

9. The electrical connection system of claim 1 wherein the mechanical coupling assembly comprises a geared arrangement and rods that in use are driven by the geared arrangement and are arranged to drive the first and second portions of the mechanical coupling assembly relative to each other.

10. The electrical connection system of claim 9 wherein the geared arrangement is positioned in the first portion of the mechanical coupling assembly and may comprise a ratcheting mechanism for imparting drive.

11. The electrical connection system of claim 10 wherein the mechanical coupling assembly comprises two rods that are oriented along the central axis of the electrical connection system and are positioned at respective eccentric positions and respective angular orientations around the central axis.

12. The electrical connection system of claim 1 wherein the first electrical connection component has a connection end at which it is arranged for connection to the second electrical connection component and a machine cable end at which it is arranged for connection to a machine cable.

13. The electrical connection system of claim 1 wherein the second electrical connection component has a connection end at which it is arranged for connection to the first electrical connection component and a machine cable end at which it is arranged for connection to a machine cable.

14. The electrical connection system of claim 1 wherein the first electrical connection component is a plug and the second electrical connection component is a receptacle, or wherein the first electrical connection component is a receptacle and the second electrical connection component is a plug.

15. The electrical connection system of claim 1 wherein:
the first electrical connection component comprises a connection part and a transfer part, wherein the connection part has connection end at which it is arranged for connection to the transfer part and a machine cable end at which it is arranged for connection to a machine cable; and wherein the transfer part may has first and second coupling faces, the first coupling face of the transfer part are arranged for coupling to the connection part and the second coupling face of the transfer part is arranged to couple to the second electrical connection component such that the transfer part is sandwiched between the coupling part of the first electrical connection component and the second electrical connection component.

16. The electrical connection system of claim 15 wherein the first portion of the mechanical coupling assembly is be removeably engageable with the connection part of the first electrical connection component and the second portion of the mechanical coupling assembly is removeably engageable with the transfer part, and wherein the mechanical coupling assembly is structured to drive the connection part and the transfer part relative to each other and between disengaged and engaged conditions.
